(19) United States
(12) Patent Application Publication
(10) Pub. No.: US 2025/0056109 A1
(43) Pub. Date: Feb. 13, 2025

(54) IMAGING SYSTEM WITH DISCRETE APERTURES

(71) Applicant: Glass Imaging Inc., Los Altos, CA (US)

(72) Inventors: Ziv Attar, Los Altos, CA (US); George Douglas MacEwen, Cupertino, CA (US); Cole Alexander Cogswell, Mountain View, CA (US)

(21) Appl. No.: 18/796,755

(22) Filed: Aug. 7, 2024

Related U.S. Application Data
(60) Provisional application No. 63/531,055, filed on Aug. 7, 2023.

(51) Int. Cl. H04N 23/55; G03B 7/095

(52) U.S. Cl. CPC H04N 23/55; G03B 7/095

(57) ABSTRACT

An imaging system may include an image sensor. The imaging system may include a strip with apertures, where a portion of the strip is located along an optical pathway that directs light to the image sensor. The imaging system may include an aperture shifter configured to move the strip relative to the optical pathway, thus allowing light propagating along the optical pathway to pass through one of the apertures of the strip and be incident on the image sensor. The imaging system may include a controller configured to control the image sensor and the aperture shifter.

### CROSS REFERENCE TO RELATED APPLICATION

This application claims priority to, and the benefit of, U.S. Provisional Application No. 63/531,055, “Mechanical Improvements for Camera Module,” filed on Aug. 7, 2023, the subject matter of which is incorporated herein by reference in its entirety.

### FIELD OF ART

The disclosure generally relates to the field of imaging systems and, in particular, to imaging systems with changeable apertures.

### BACKGROUND

Many cameras include an iris diaphragm to control the size of the camera aperture. Iris diaphragms usually include a series of overlapping plates that can be adjusted to change the size of a central hole. Adjusting these plates can either constrict or widen the aperture, allowing for control over the light's intensity and focus. However, by forming the camera aperture with these overlapping plates, the resulting aperture shape includes corners that can cause diffraction spikes and affect the shape of the bokeh in an image. Thus, an iris diaphragm cannot form an aperture with a smooth shape (e.g., a circle or oval), especially across the range of aperture size settings. Additionally, iris diaphragms are large and require space around the entire optical axis. Thus, iris diaphragms are insufficient for space constrained cameras or cameras that do not include equal space around the optical axis.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

(FIGS.) 1A and 1B illustrate an imaging system contained in a mobile device, according to one or more embodiments.

FIGS. 2A-2C illustrate the imaging system capturing images of different portions of a view of an external environment, according to one or more embodiments.

FIG. 2D illustrates the images of the portions of the view, according to one or more embodiments.

FIG. 2E illustrates an image of the view of the external environment formed from the images in FIG. 2D, according to one or more embodiments.

FIG. 3A is a diagram of an aperture strip, according to one or more embodiments.

FIG. 3B is a block diagram of an imaging system with an aperture system, according to one or more embodiments.

FIGS. 4A-4C are diagrams of another imaging system with an aperture system, according to one or more embodiments.

FIG. 5 is a diagram of an aperture strip coupled to a linear actuator, according to one or more embodiments.

FIG. 6 is a diagram of an aperture strip coupled to a gear, according to one or more embodiments.

FIG. 7 is a flowchart of an example method 700 for capturing images using different apertures, according to one or more embodiments.

FIGS. 8A-8E are diagrams of another imaging system with an aperture system, according to one or more embodiments.

FIG. 9 is a block diagram illustrating components of an example machine able to read instructions from a machine-readable medium and execute them in a processor (or controller), according to an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Introduction

Imaging systems may include an aperture system with multiple discrete apertures that can be switched during operation of the imaging system. Each of the apertures may be different from one another to provide the imaging system with a wide variety of apertures that can be quickly switched for different image capturing applications or scenarios.

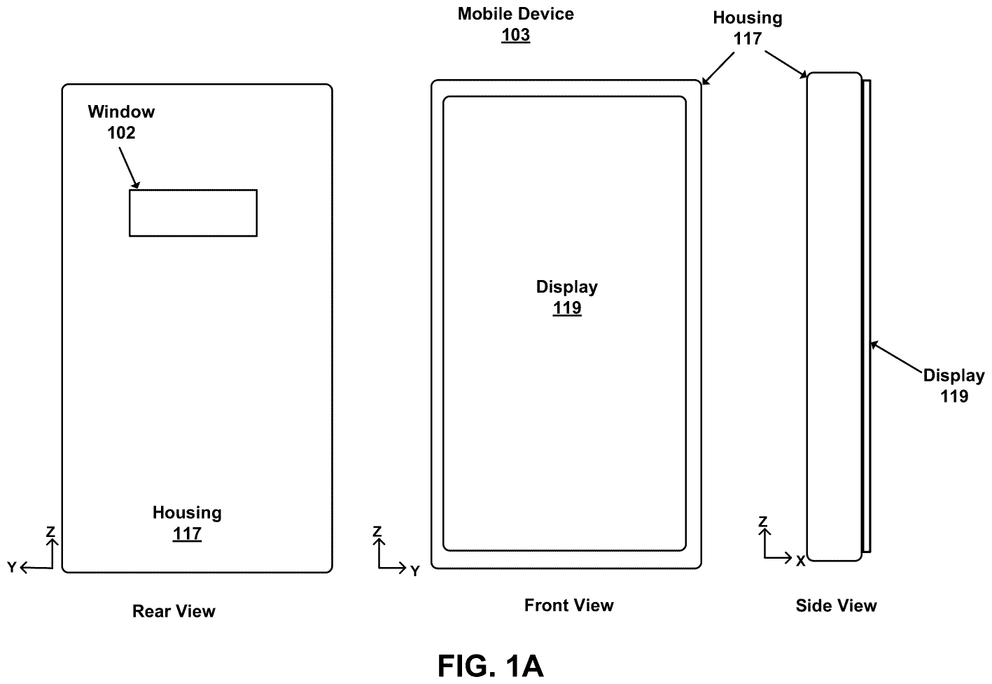

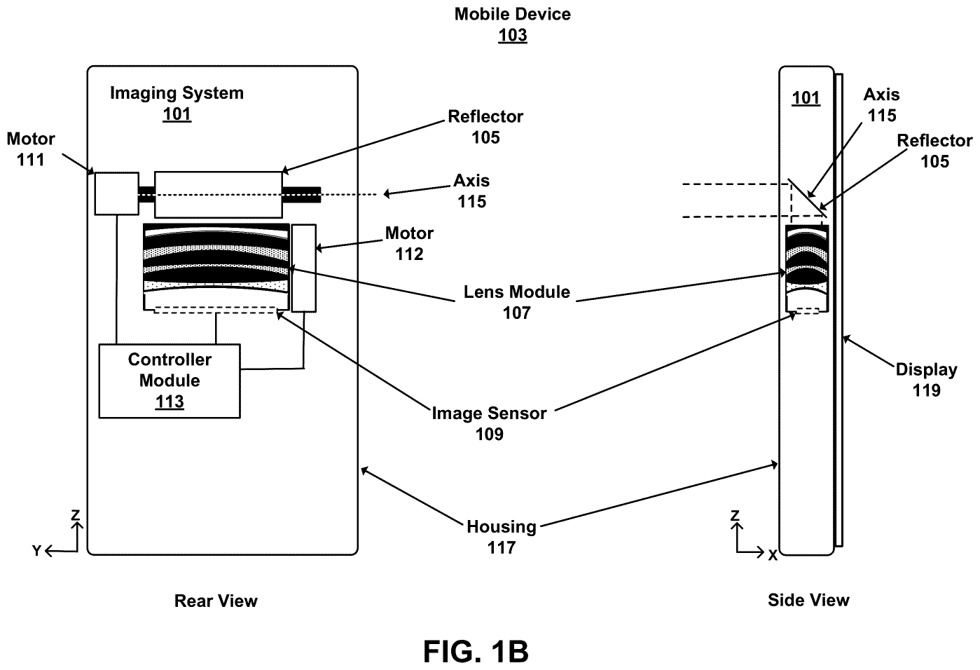

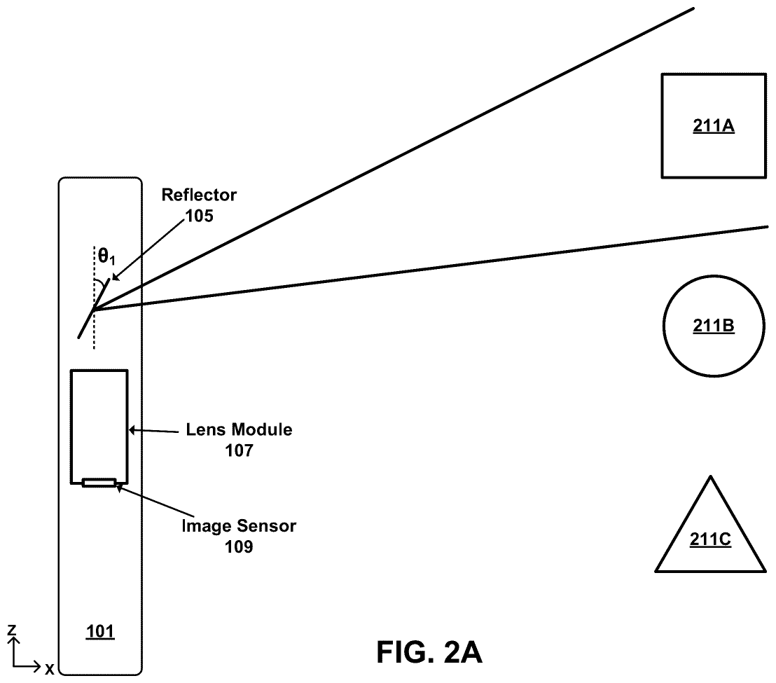

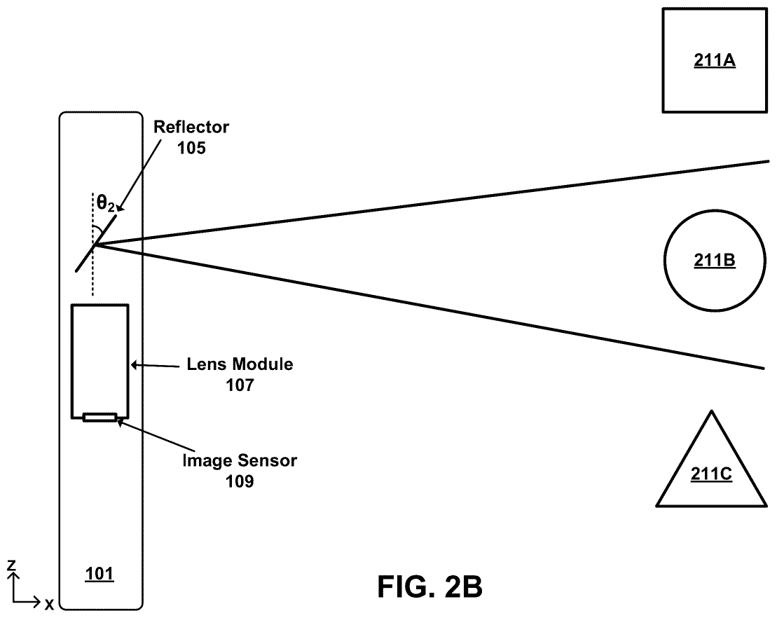

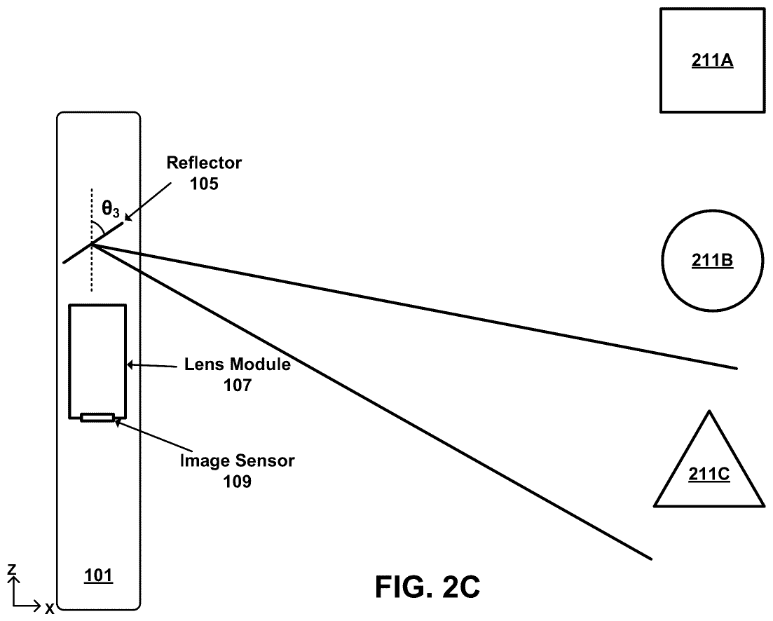

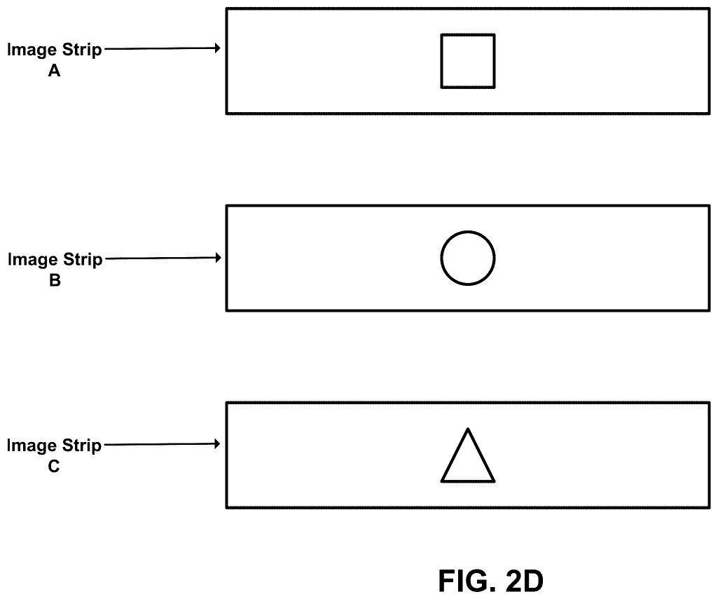

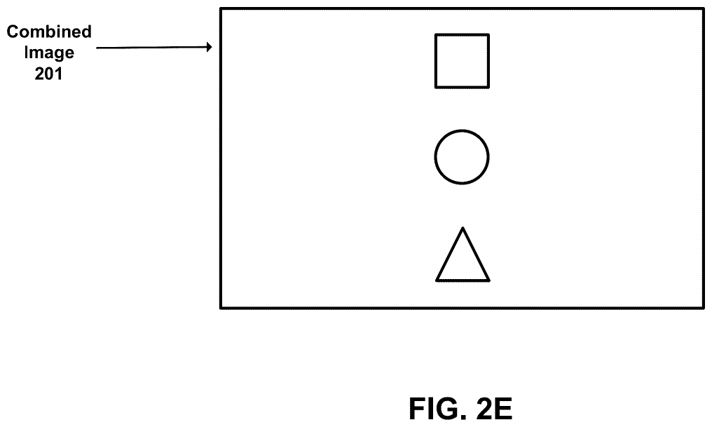

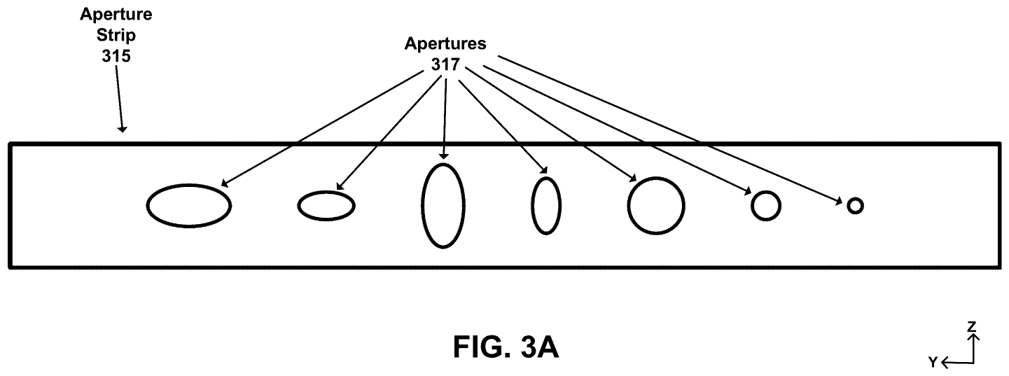

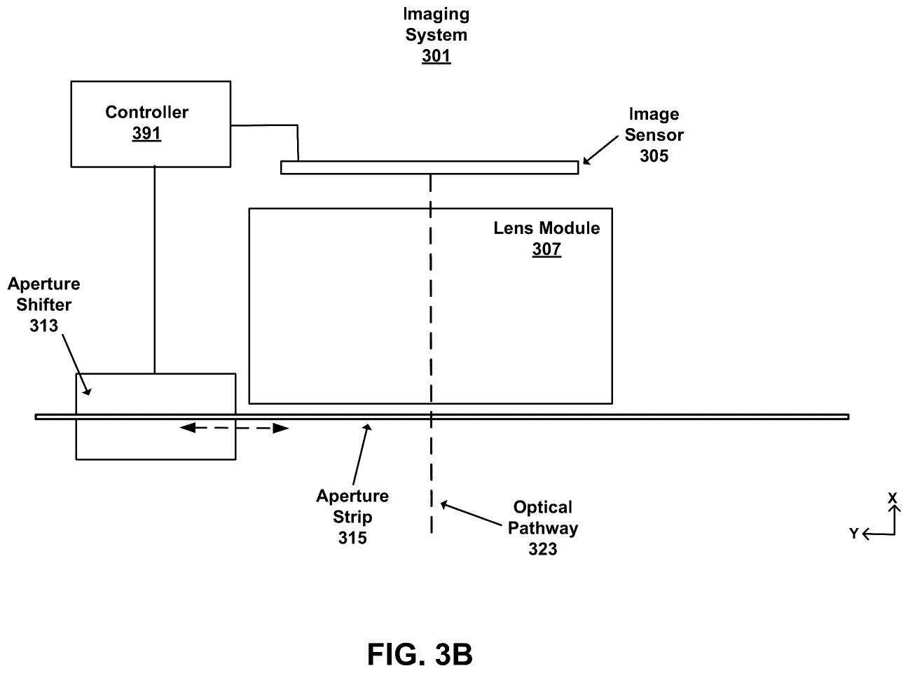

Aperture systems are further described with reference to FIGS. 3A-8E. But first, FIGS. 1A-2E and their descriptions describe example imaging systems with a reflector. The aperture systems described herein may be implemented in a wide variety of different imaging systems, such as the imaging systems described with reference to FIGS. 1A-2E. For example, an aperture strip (e.g., 315, 415) of an aperture system may be placed: (a) between the reflector (e.g., 105) and the housing window (e.g., 102) or (b) between the reflector (e.g., 105) and the lens module (e.g., 107). The length of the aperture strip may be along the y-axis (e.g., see FIG. 1B).

### Example Imaging Systems

FIGS. 1A-1B (“FIG. 1” collectively) illustrate an example imaging system 101 contained in an example mobile device 103, according to an embodiment. Specifically, FIG. 1A illustrates a front, rear, and side view of the mobile device 103, and FIG. 1B illustrates a cross-sectional rear view and cross-sectional side view of the mobile device 103. The mobile device 103 includes the imaging system 101, a housing 117 with a window 102, and a display 119. The imaging system 101 includes a rotatable reflector 105, a motor 111, a motor 112, a lens module 107 (also referred to as a lens design), an image sensor 109, and a controller module 113.

The reflector 105 directs light passing through the window 102 downward towards the lens module 107. The lens module 107 focuses light onto the image sensor 109. The motor 111 rotates the reflector 105 about axis 115, which is substantially parallel (e.g., within a three degrees) to the image sensor plane. Rotating the reflector 105 allows the reflector 105 to direct light from different portions of the external environment towards the image sensor 109. The controller 113 is electrically coupled to the image sensor 109 and the motor 111. To form an image of the external environment, the imaging system 101 captures images of portions of a view of the external environment while rotating the reflector 105. The rotation of the reflector 105 from an initial angular position to a final angular position may be referred to as a scan. The sequence of captured images contains information of several adjacent portions of the environment and, after combining (e.g., stitching or fusing) the images together, the imaging system 101 forms a larger image of the external environment with a predetermined aspect ratio.

The housing 117 contains one or more of the components of the imaging system 101. Locations and orientations of the imaging system components may be described relative to the housing 117 and a housing window 102. For example, the housing 117 is defined by multiple walls that contain the imaging system 101, and one of the walls includes a housing window 102 with a plane, for example, defined by a boundary of the window 102. The plane may be parallel to an yz- (or yz-) plane in a three-dimensional reference system. The housing 117 may have a low profile along an axis perpendicular to the plane of the window 102 (e.g., along the x-axis). The length of the housing along the x-axis may be referred to as the thickness of the housing 117 and may range from, for example, 5 to 15 millimeters. In embodiments where the housing 117 is part of a mobile device 103, the window plane may be parallel to a display 119 of the mobile device 103. Unlike conventional imaging systems, the image sensor surface does not face the window plane. For example, the image sensor surface is perpendicular to the window plane (e.g., parallel to the xy-plane) and is outside the boundary of the window 102. Due to this, the reflector 105 may be aligned with the window 102 to direct light propagating through the window 102 to the image sensor plane. The lens module 107 may be between the reflector 105 and the image sensor 109. An aperture plane may be between the reflector 105 and the lens module 107 and may be perpendicular to the window plane and parallel to the image sensor plane. The reflector allows the optical path of the imaging system 101 to be folded into the yz-plane. This folding allows the optical path to increase beyond the limit of the housing's thickness and into the housing's width (e.g., length along the y-axis) and height (e.g., length along the z-axis), which are typically larger than its thickness. Thus, the reflector, the image sensor, and/or an aperture of the lens module 107 may have aspect ratios that are not 1:1, and their long axes may be parallel to each other.

The terms “parallel” and “perpendicular” as used herein may refer to components being substantially parallel or substantially perpendicular (e.g., within three degrees) since manufacturing components that are perfectly parallel or perpendicular may be practically difficult to achieve.

The image sensor 109 is an imaging device that captures images of portions of the external environment. The image sensor 305 may be, for example, a charge coupled device (CCD) sensor or a complementary metal-oxide semiconductor (CMOS) sensor. As illustrated in FIG. 1, the image sensor surface may lie in the xy-plane relative to an xy-plane of the mobile device 103 and the image sensor surface faces in a perpendicular direction (along the z-axis) from the xy-planar surface. Due to this positioning, the sensor plane of the image sensor 109 does not face the view of the external environment. By placing the image sensor 109 in the xy-plane, the size of the image sensor 109 can be larger than image sensors in conventional cameras. The smaller dimension of the image sensor plane (along the x-axis) may be limited by the mobile device thickness while the longer dimension (along the y-axis) may be limited by the mobile device width, which may be many centimeters long. This allows the image sensor 109 to have a high aspect ratio, such as ratio greater than 17:9 (e.g., 1:10). Conventional cameras produce image of scenes with aspects ratios that are not as high. Due to the high aspect ratio of the image sensor 109, the image sensor 109 may create narrow images (“image strips”) that correspond to a narrow view of the scene. For conventional imaging systems in mobile devices, the size of the image sensor may be limited by the focal length of the camera lens. However, by changing the location and orientation of the image sensor 109 as described herein, the image sensor size may be larger than image sensors in conventional imaging systems with a same or similar housing.

As described above, the reflector 105 (also referred to as a scanning mirror) is an optical component that rotates about axis 115 to direct light to the image sensor 109. Generally, axis 115 is substantially parallel to a long dimension of the image sensor plane and the reflector 105 is centered on window 102. If the plane of the window 102 (e.g., the yz-plane) is perpendicular to the plane of the image sensor 109 (e.g., the xy-plane), the reflector 105 may direct light at around a 45-degree position relative to the image sensor plane to direct light towards the image sensor 109. Due to the high aspect ratio of the image sensor 109, the reflector 105 may also have a high aspect ratio to ensure light is reflected to the entire surface of the image sensor 109. The reflector 105 is illustrated in FIG. 1B as having a rectangular plane, however other shapes are possible, such as concave or convex shapes (e.g., which may be used to expand or shrink the field of view).

The reflector 105 is described herein in terms of ‘directing’ light, however this is for ease of description. The reflector 105 may optically direct, widen, slim, reflect, diffract, refract, disperse, amplify, reduce, combine, separate, polarize, or otherwise change properties of the light as it propagates in the imaging system 101. To do this, the reflector 105 may include reflective coatings, metalized features, optical gratings, mirrors, prismatic structures, Fresnel structures, corner reflectors, retroreflectors, and the like on one or more of its surfaces.

The lens module 107 includes one or more optical components and is designed to form an image on the image sensor 109. The lens module 107 may spread, focus, redirect, and otherwise modify the light passing through it. The lens module 107 may be a single lens or it may include additional optical components, such as diffusers, phase screens, beam expanders, mirrors, and lenses (e.g., anamorphic lenses). In some embodiments, the entrance pupil of the lens module 107 is adjacent to the reflector 105. This may allow the reflector 105 to have a smaller size. In some embodiments, the lens module 107 include a non-symmetrical aperture with one large and one small axis (stretching an axis may be used in devices that have dimension constrains, like smartphones, and in those cases the aperture can be much larger if it isn't symmetrical).

Because of the high aspect ratio of the image sensor 109, the lens module 107 may be designed and manufactured to be non-circular or non-symmetric and follow the dimension of the image sensor 109 in the terms of its aperture. Using a lens module 107 with a non-symmetrical aperture may allow it to fit in the mobile device housing 117. Furthermore, the focal length of the lens module 107 may be different in the x- and y-directions. In some embodiments, this results in the imaging system 101 not preserving the aspect ratio, so, for example, a 4:3 scene may be imaged by an image sensor that is 8:3. One or more of the optical components of the lens module 107 may have surfaces with cylindrical symmetry but the apertures of other components may be rectangular or another elongated shape. The lens module 107 may be manufactured using wafer level technology, which may be beneficial in creating rectangular shaped optical components by dicing lens surfaces in the desired aspect ratio. In some embodiments, the lens module 107 is manufactured using injection molding technology by creating molds that have non-symmetrical apertures. The components of the lens module 107 may be glass or plastic injection molded or machined (e.g., via wafer level technology).

The motor 112 is controlled by controller 113 and is configured to move the lens module or one or more optical components of the lens module 107. For example, the motor 112 moves one or more optical lenses along the optical axis to focus light onto the sensing plane of the image sensor 109. The imaging system may include multiple motors 112, for example, if multiple optical components should be moved separately or by different amounts. The motor 112 may include one or more actuator type mechanisms, one or more galvanometer type mechanisms, one or more mems type mechanisms, one or more motorized type mechanisms, one or more stepper motor type mechanisms, or some combination thereof. The motor 112 may also be referred to as a lens shift mechanism.

As stated above, the motor 111 rotates the reflector 105 around axis 115. To do this, the motor 111 may include one or more actuator type mechanisms, one or more galvanometer type mechanisms, one or more mems type mechanisms, one or more motorized type mechanisms, one or more stepper motor type mechanisms, or some combination thereof. In some embodiments, the motor 111 can move the reflector 105 in other directions. For example, the motor 111 can translationally and/or rotationally move the reflector 105 along the x axis, y axis, z-axis, or some combination thereof.

In some embodiments, motor 111 tilts the reflector 105 (e.g., by a few degrees in either direction) to compensate for motion (e.g., hand motion) while the image sensor 109 is capturing an image of a portion of the scene. For example, if a user tilts the mobile device 103 slightly downward, the motor may tilt the reflector 105 upward to compensate for the motion so that the image sensor 109 receives a same portion of the scene despite the tilting. In some embodiments, the imaging system 101 includes a sensor shift mechanism (e.g., another motor) to shift the image sensor 109 in one or more directions (e.g., in the xy-plane) to compensate for this motion. In some embodiments, the imaging system 101 includes motor 112 to shift the lens module 107 (or a component of it) in one or more directions (e.g., in the xy-plane) to compensate for this motion. If the imaging system 101 includes multiple motion compensating mechanisms, the controller 113 may coordinate the multiple mechanisms to work in conjunction to offset motion. For example, the motor 111 tilts the reflector 105 to compensate for motion in one direction and a sensor shift mechanism or a lens shift mechanism (e.g., 112) compensates for motion in another direction. In some embodiments, the reflector 105 rotates about multiple substantially perpendicular axes (e.g., the x-axis and z-axis) to compensate for motion (e.g., instead of a sensor or lens shift mechanism).

The motor 111 and shift mechanisms (e.g., 112) may also act as auto focusing mechanisms. For example, a lens shift mechanism shifts the lens module 107 (or a component of it) closer to or farther away from the image sensor 109 (e.g., along the z-axis) to achieve the desired focus. In another example, a sensor shift mechanism shifts the image sensor 109 closer to or farther away from the lens module 107 (e.g., along the z-axis) to achieve the desired focus.

The controller module 113 may constitute software (e.g., program code embodied on a machine-readable medium and executable by a processing system to have the processing system operate in a specific manner) and/or hardware to provide control signals (also referred to as adjustment signals) to the motor 111, motor 112, image sensor 109, or some combination thereof. Thus, the controller 113 may: (1) rotate the reflector 105 via motor 111 to direct light from different portions of the external environment towards the image sensor 109, (2) focus light on the image sensor 109 by adjusting optical components of the lens module 107 via motor 112, (3) synchronize the image sensor 109 with the reflector 105 to capture images of the different portions of the environment, or (4) some combination thereof. Additionally, the controller 113 may receive the captured images and combine them to form a lager continuous image of the external environment.

In some embodiments, the imaging system 101 includes one or more motion sensors (e.g., accelerometers, gyroscopes, etc.) to track motion of the imaging system relative to the external environment. The controller module 113 may receive motion data from the motion sensors. If the determined motion is above a threshold amount, the module 113 may provide instructions to the motor 111 and/or a sensor shift mechanism to compensate for the motion.

In some embodiments, the imaging system 101 is not contained in the mobile device 103. For example, the imaging system 101 is contained in a standalone device, such as a case for the mobile phone 103.

FIGS. 2A-2C illustrate the imaging system 101 capturing images of different portions of a view of an external environment, according to an embodiment. In the example of FIGS. 2A-2C, the external environment includes one or more objects within a field of view. In this example, for ease of discussion, the objects are a cube 211A, a sphere 211B, and a pyramid 211C that are vertically aligned. In FIG. 2A, the reflector 105 is tilted at a first rotational position (e.g., it forms angle θ₁ relative to the yz-plane) to direct light from the top portion of the external environment towards the image sensor 109. Thus, the image sensor 109 captures an image of the cube 211A. In FIG. 2B, the reflector is tilted at a second rotational position (e.g., it forms angle θ₂>θ₁ relative to the yz-plane) to direct light from the middle portion of the external environment toward the image sensor 109. Thus, the image sensor 109 captures an image of the sphere 211B. In FIG. 2C, the reflector is tilted at a third rotational position (e.g., it forms angle θ₃>θ₂ relative to the yz-plane) to direct light from the bottom portion of the external environment toward the image sensor 109. Thus, the image sensor 109 captures an image of the pyramid 211C. In some example embodiments, to capture a set of images, the reflector angles θ may range symmetrically around the 45 degree position (e.g., from 25-65 degrees) relative to the xy-plane.

FIG. 2D illustrates three image strips that were captured by the image sensor 109, according to an embodiment. Each image strip is an image of a different portion of the external environment due to each strip being captured while the reflector 105 was in a different rotational position. The image strips have high aspect ratios due to the high aspect ratio of the reflector 105, lens module 107, and image sensor 109. Image strip A is an image of the cube 211A and was captured by the image system 101 in FIG. 2A. Image strip B is an image of the sphere 211B and was captured by the image system 101 in FIG. 2B. Image strip C is an image of the pyramid 211C and was captured by the image system 101 in FIG. 2C.

The exposure time to capture each image strip may be limited by user motion (the user unintentionally moving the device 103 as they hold it) and by objects moving in the scene. Additionally, the total exposure time of the image strips may be limited by possible changes in the external environment between the capturing of image strips. The image strip exposure times and the total exposure time may be limited to predetermined threshold times or determined dynamically (e.g., based on an amount of movement of the mobile device 103).

FIG. 2E illustrates an image 201 of a view of the external environment, according to an embodiment. The image 201 is formed by combining (e.g., fusing or stitching) image strips A-C illustrated in FIG. 2D. The combined image 201 may be referred to as a composite image. The horizontal field of view of the combined image 201 may be based on the width (along the y-axis) of the window 102, reflector 105, lens module 107 (e.g., its aperture), and/or image sensor 109, and the vertical field of view of the combined image 201 may be based on the scanning range of the reflector 105. Typically, the vertical field of view is larger than the horizontal field of view.

Depending on the position of the reflector 105 when image strips are captured, the image strips may have some overlap with each other (e.g., 10-300 rows of pixels). Capturing image strips with overlap may help ensure that the image strips are not missing portions of a view of the environment (e.g., so that the entire view is captured) and may reduce the noise value of the combined image 201. Capturing image strips with overlap may also assist the combination process to ensure the image strips are combined properly. For example, the controller 113 uses overlapping portions to align the image strips during the combination process. In another example, if objects in the environment move between the capturing of image strips or if the mobile device 103 moves between the capturing of image strips, the control system 101 may use the overlapping portions to correct for artifacts caused by this movement.

### (i) Rotating the Reflector

The rotation of the reflector 105 may be discrete such that it rotates from an initial (e.g., maximal) angular position of the reflector 105 to the final (e.g., minimal) angular position with N stops, where N is the number of image strips which will form a combined image. N may be as small as two. N may depend on the desired exposure time of the combined image and/or the size of the smaller dimension of the image sensor 109 and the desired size or aspect ratio of the combined image. For example, if the image sensor has 24,000 pixels by 6,000 pixels and if the final combined image is to have a 4:3 aspect ratio, then the reflector 105 will have three discrete positions and the combined image will be 24,000 pixels by 18,000 pixels. The previous scanning example did not include any overlap in the image strips. If N is increased, then some areas in the scene will appear more than once in the image strips. For example, if the scanning is done using six discrete angular positions, then each point in the scene will appear in two image strips.

The imaging system 101 may be capable of capturing videos. In these cases, combined images may form frames of the video. If the video frame rate or preview frame rate is, for example, 25 FPS (frames per second) the total exposure time for each combined image is 40 milliseconds or less. In the case of a three discrete position scanning, each position may be exposed for 13.33 milliseconds. However, the reflector 105 needs time to change its position and to come to a stop, which means the exposure time may be around 10 milliseconds for each image strip.

For still image capture it is possible to interrupt an image preview displayed to the user when the user presses the capture button and allow longer exposure than the one limited by the image preview speed.

The above considerations considered a full field of view. If the imaging system 101 captures a narrower field of view, it may reduce the scanning range of the reflector 105. For example, if a user zooms in by a factor of three (i.e., 3× zoom), the imaging system 101 may not perform any scanning. Accordingly, the reflector 105 may be stationary. For example, if the image sensor 109 has 24,000 pixels by 6,000 pixels and the final image has a height of 6,000 pixels and an aspect ratio of 4:3, the reflector 105 may not rotate and the other dimension of the image may be 8,000 pixels (e.g., read out and cropped from the 24,000 pixel dimension of the image sensor 109).

In some embodiments, the rotation of the reflector 105 is continuous instead of discrete. In a continuous scanning mode, the reflector 105 continuously rotates at a speed that is slow enough that the captured images are not blurry, yet fast enough to finish scanning a desired field of view at desired frame rate (e.g., 40 milliseconds). In a continuous mode, the rotation rate of the reflector 105 may be dictated by a desired frame rate. For example, if a frame rate is 30 FPS (33 milliseconds between frames), the scene scanning takes around 25 milliseconds and then the reflector 105 is rotated back to its initial position. Other example values are possible, such as 30 milliseconds, depending on the how fast the reflector can be rotated back to its initial position. In embodiments where the reflector 105 is two sided, the reflector 105 may not need to be rotated back to its initial position.

In a continuous scanning mode, points in the external environment may appear on every line of pixels during a scan. The image sensor 109 may capture enough images so that a point is captured by each row of pixels for consecutive image strips. For example, if the image sensor 109 includes 6000 rows of pixels, it may capture 6000 images during a single scan. To do this, for example, an image sensor may, instead of integrating charge on one pixel for a certain number of milliseconds, integrate charge from changing pixels. If this change (scan) is synchronized with the reflector rotational speed, then the output can correspond to one point in space. An example implementation of this with an image sensor 109 is reading out just one pixel row, which can happen very quickly. So, for example, a sensor that does 30 FPS (frames per second) and has 6000 rows can perform 15000 FPS with reading out just one row. Alternative to capturing enough images so that a point is captured by each row of pixels, the image sensor 109 may capture a predetermined number of images during a scan that is less than the number of pixel rows.

### Example Aperture Systems

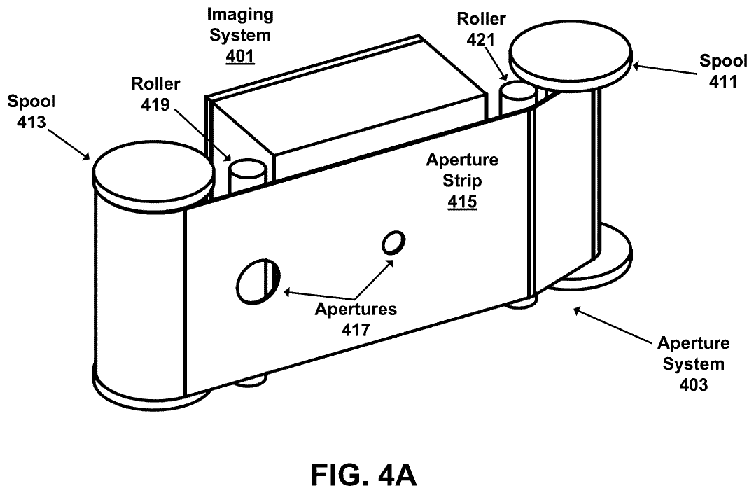

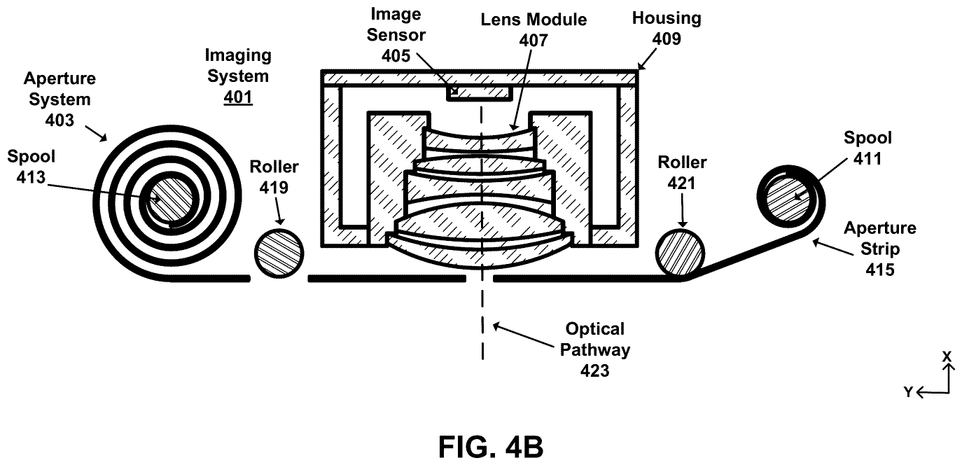

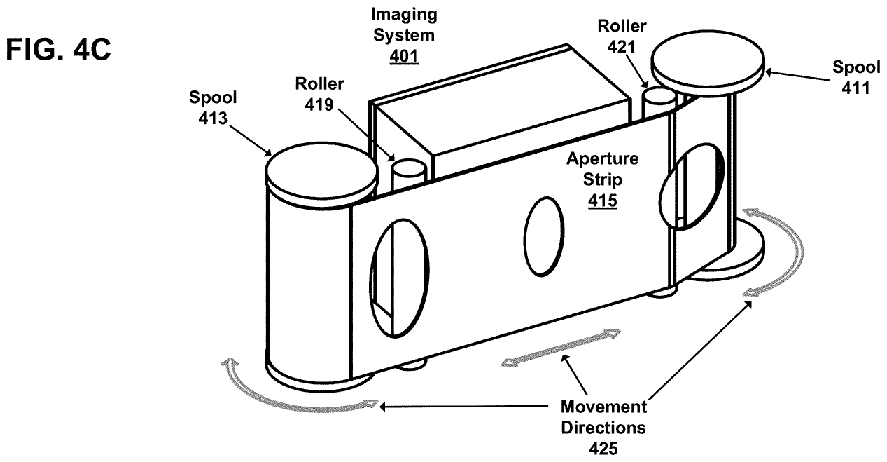

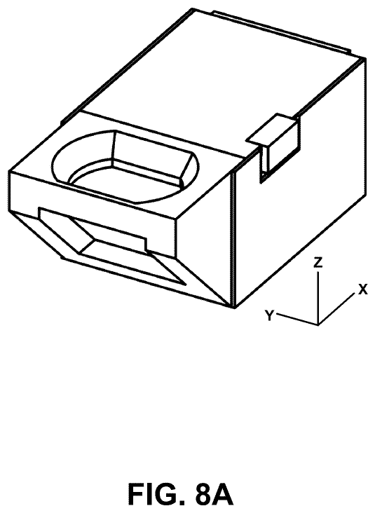

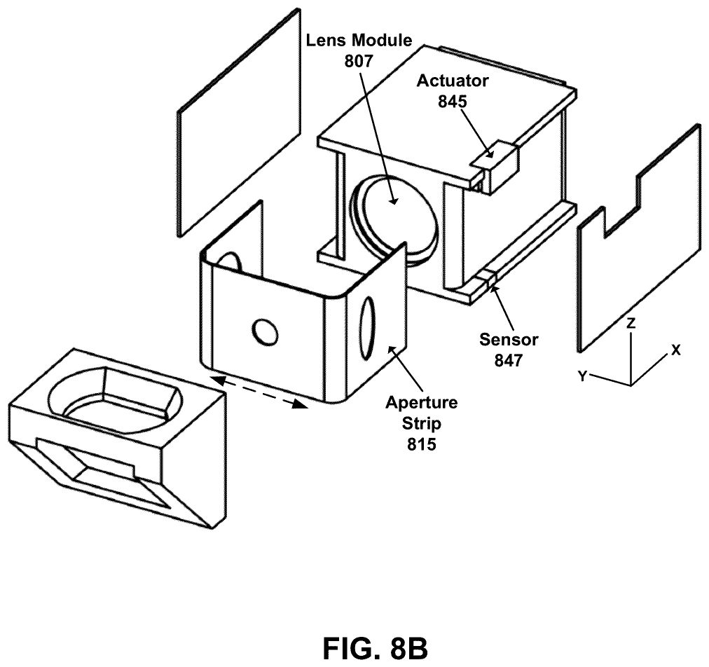

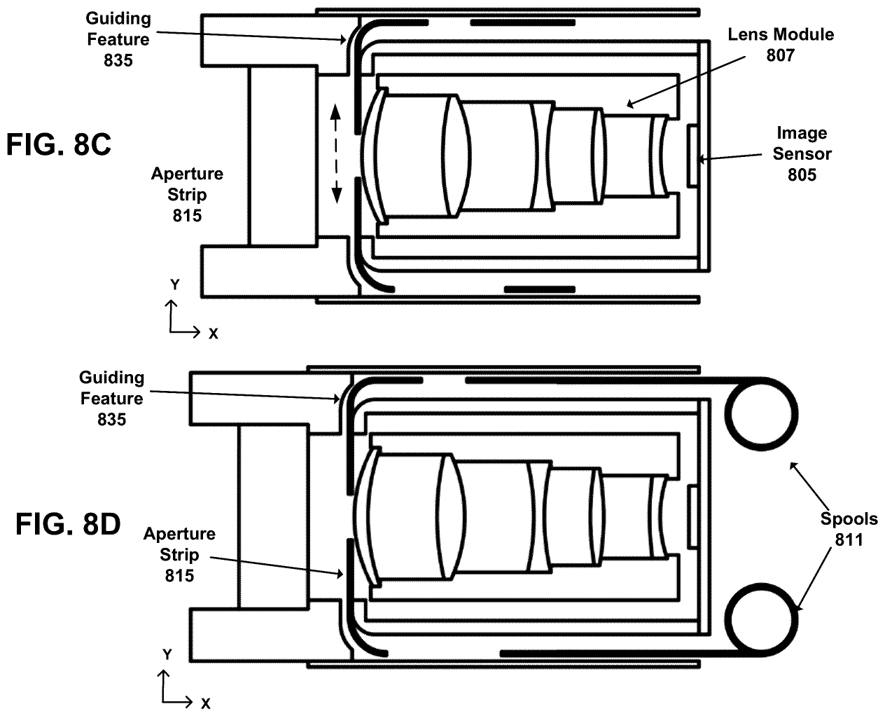

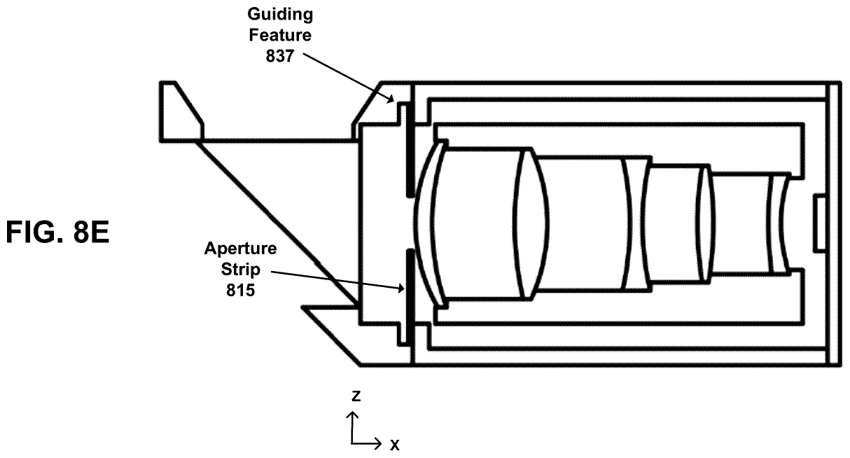

As previously stated, imaging systems may include an aperture system with multiple discrete apertures that can be switched during operation of the imaging system. Each of the apertures may be different from one another to provide the imaging system with a wide variety of apertures that can be quickly switched for different image capturing applications or scenarios. Furthermore, aperture systems described herein may be advantageous for imaging systems that are space constrained in areas at or around the aperture location. For example, the thickness of an aperture strip (further described below) along the optical pathway may be thinner than that thickness of an iris diaphragm at the same location. Similarly, iris diaphragms require space around the entire optical pathway axis at the location of the aperture. In contrast, components of aperture systems described herein may be located away from the location of the aperture (except for the aperture strip). See e.g., FIGS. 4A-4C and 8A-8E. Furthermore, the aperture of an iris diaphragm includes corners that can cause diffraction spikes and affect the shape of the bokeh in an image. In contrast, aperture systems described herein can include apertures with smooth shapes (e.g., circles and ovals) for a range of aperture sizes.

FIG. 3A is a diagram of an example aperture layout, e.g., aperture strip 315, according to one or more embodiments. The strip 315 includes seven discrete apertures 317 along the length of the strip. The strip 315 may be moved (e.g., horizontally translated) to align one of the apertures with an optical pathway of an imaging system. An aperture strip (e.g., 315) is generally planar in shape. Furthermore, although strip 315 is rectangular in shape (in the 2D plane of FIG. 3A) and the term “strip” suggests a rectangular shape (in a 2D plane), this is not required. An aperture strip may have other shapes (in the 2D plane), such as a square or circle. An aperture strip may be opaque (e.g., to wavelengths detectable by an image sensor of the corresponding imaging system). An aperture strip (e.g., 315) may be made of bendable material (e.g., configured to wrap around a spool) or it may be made of a firm or rigid material configured to maintain its shape even when moved. To be opaque and flexible, an aperture strip may be made of materials such as polyester, silicone film, polymide, metallized polymer film, BoPet, or some combination thereof.

In the example of FIG. 3A, the first aperture (first on the left) has a large oval shape with the long axis parallel to the length strip. The second aperture (from the left) has a small oval shape with the long axis parallel to the length of the strip. The third aperture (from the left) has a large oval shape with the long axis perpendicular to the length of the strip. The fourth aperture (from the left) has a small oval shape with the long axis perpendicular to the length of the strip. The fifth aperture (from the left) has a large circular shape, the sixth aperture (from the left) has a medium circular shape, and the sixth aperture (from the left) has a small circular shape). Other aperture strips may include different, additional, or fewer apertures.

An aperture of an aperture strip (e.g., 315) may include an optical filter (or multiple filters). For example, an aperture of an aperture strip may include vertical polarizer, a horizontal polarizer, a circular polarizer, an apodization filter, neutral density filter, a linear gradient filter, a radial gradient filter, or some combination thereof. A filter may filter out or allow any combination of: visible wavelengths or non-visible wavelengths.

As indicated by the oval apertures of strip 315, an aperture strip can include a non-symmetrical aperture that includes a large axis and a small axis. This may be useful for imaging systems with a non-symmetrical lens or image sensors with high aspect ratios.

FIG. 3B is a block diagram of an overhead view of an example imaging system 301 that includes the aperture strip 315, according to one or more embodiments. The imaging system additionally includes a lens module 307, an image sensor 305, an aperture shifter 313, and a controller 391. The controller 391 is coupled with the aperture shifter 313 and the image sensor 305. The lens module 307 is structured between the image sensor 305 and the aperture strip 315. The aperture shifter 313, controller 391, and strip 315 may be collectively referred to as an aperture system. The imaging system 301 may include different, additional, or fewer components than as illustrated.

The image sensor 305 is an imaging device that captures images of an external environment. The image sensor 305 may be, for example, a charge coupled device (CCD) sensor or a complementary metal oxide semiconductor (CMOS) sensor.

The lens module 307 includes one or more optical components and is designed to form an image on the image sensor 305. The lens module 307 may spread, focus, redirect, and otherwise modify the light passing through it. The lens module 107 may be a single lens or it may include additional optical components, such as diffusers, phase screens, beam expanders, mirrors, and lenses (e.g., anamorphic lenses). The lens module 307 may be designed and manufactured to be non-circular or non-symmetric. The focal length of the lens module 307 may be different along the two dimensions perpendicular to the optical axis. The lens module 307 may be manufactured using wafer level technology. In some embodiments, the lens module 307 is manufactured using injection molding technology by creating molds that have non-symmetrical apertures. The components of the lens module 307 may be glass or plastic injection molded or machined (e.g., via wafer level technology).

In the imaging system, an optical pathway 323 illustrates that light propagates through an aperture of the aperture strip 315 (when an aperture is aligned with the optical pathway 323), through the lens module 307, and to the image sensor 305. Other optical pathway arrangements are possible though. For example, the aperture strip 315 may be placed between lenses of the lens module 307 or between the lens module 307 and the image sensor 305.

The aperture shifter 313 is controlled by signals transmitted from the controller 391. The aperture shifter 313 includes components to hold the aperture strip 315 in place and to move the aperture strip 315 to align one of the apertures with the optical pathway 323. To hold the aperture strip 315 in place, the aperture shifter 313 may include any combination of one or more slides, one or more tracks (or rails), one or more trays, one or more clips, one or more wheels, one or more spools, and one or more rollers, among other possible components (depending on the structure and material of the strip 315). To move the strip 315, the aperture shifter 313 may include (among other possible components) one or more actuators (e.g., a piezoelectric actuator), one or more galvanometers, one or more mems mechanisms, one or more motors (e.g., linear or rotational motors), or some combination thereof (depending on the structure and material of the strip 315). The below descriptions with respect to FIGS. 4A-6 include additional descriptions of aperture shifters.

In the example of FIG. 3B, the aperture shifter 313 can move the strip 315 horizontally i.e., along the y-axis (indicated by the dashed horizontal arrows). However, depending on the location and alignment of the apertures on the strip 315 relative to the optical pathway 323 or the lens module 307, the aperture shifter 313 can be configured to translate or rotate the strip 315 along any combination of the x, y, and z axes. In the example of FIG. 3B, the aperture shifter 313 is only on the left side of the strip 315, however the aperture shifter 313 (or components of the aperture shifter 313) may be on other sides of the strip 315 or on multiple sides of the strip 315 (e.g., on the left and right sides).

The controller 391 (also “controller module”) may constitute software (e.g., program code embodied on a machine-readable medium and executable by a processing system to have the processing system operate in a specific manner) and/or hardware to provide control signals (also referred to as adjustment signals) to the aperture shifter 313, image sensor 305, or some combination thereof. Thus, the controller 391 may: (1) move the strip 315 relative to the optical pathway 323 so that an aperture 317 of the strip 315 is aligned with the optical path 323 (by controlling the aperture shifter 313), (2) capture an image by the image sensor 305 (by controlling the image sensor 305), or some combination thereof.

In some embodiments, the controller may (1) move the strip so that an aperture is not precisely aligned with the optical path but allows light to pass through the lens module to the image sensor, (2) capture an image by the image sensor. Repeating this process two or more times with different aperture positions so the image sensor captures data that may be used to analyze scene information (e.g. object distance from the imaging system). Also, the aperture position for the first image may be optically aligned while the second is not (or vice versa). To gather additional data, the two images may be captured with an aperture in two different positions regardless of alignment the optical axis, or two images with two different apertures that may or may not be aligned to the optical axis.

The controller 391 may determine which aperture to align with the optical pathway 323. For example, the controller 391 receives a signal based on input from a user of the imaging system 301 (e.g., specifying an aperture setting) that is used to generate a signal transmitted to the aperture shifter 313. The aperture shifter 313, upon receipt of the signal, moves the aperture strip to align the desired aperture with the optical pathway 323. Additionally, or alternatively, the controller 391 may determine the aperture based on signals from one or more sensors of the imaging system 301. For example, if a signal from the image sensor 305 indicates the environment has low ambident light, the controller 391 may determine that a larger size and/or shape of aperture is appropriate. The controller 391 thereafter generates a signal that is transmitted to the aperture sifter 313. The aperture shifter 313 upon receipt of the signal shifts the aperture strip to align the determined apertures with the optical pathway 323.

The controller 391 may be capable of performing additional functionalities. Furthermore, the controller 391 may be part of other controllers (e.g., if the imaging system 101 includes an aperture system, the controller 391 may be part of the controller 113).

FIG. 4A is a perspective diagram of an example imaging system 401 with an aperture system 403 that enables changing of apertures, according to one or more embodiments. FIG. 4B is a top cross-sectional view of the example imaging system of FIG. 4B, according to one or more embodiments. FIGS. 4A and 4B are described together. In addition to the aperture system 403, the imaging system 401 includes a lens module 407 and an image sensor 405 mounted in a housing 409. Imaging system 401 is an example embodiment of imaging system 301. The imaging system 401 may include different, additional, or fewer components than as illustrated. For example, the aperture system 403 additionally includes a motor that rotates the spools and a controller (e.g., 391) that controls the spool motor.

The aperture system 403 includes an aperture strip 415, spool 411, spool 413, support roller 419 and support roller 412. The aperture strip 415, similar to aperture strip 315, includes a set of discrete apertures 417 along the length of the strip (only two apertures are illustrated in the examples of FIGS. 4A and 4B). The spools 411, 413 hold the aperture strip 415 in place and store portions of the aperture strip 415. Said differently, a first portion of the aperture strip 415 is wound around spool 413 and a second portion of the aperture strip 415 is wound around spool 411. The aperture system 403 may be held taunt by a moment created by the spools 411, 413 allowing for the ability to rapidly cycle through the discrete apertures. As illustrated, spool 413 is on a left side of the optical pathway 423 and spool 411 is on a right side of the optical pathway 423.

The rollers 419, 421 support the aperture strip 415 so it remains flat and aligned in front of the lens module 407. The rollers 419, 421 may rotate as the strip 415 is moved.

The aperture strip may be (e.g., quickly) moved relative to the optical pathway 423 to change apertures of the imaging system 401. To do this, the spools 413, 415 may be rotated (e.g., by one or more motors that are controlled by a controller (not shown)) to slide between apertures in the strip 415. For example, both spools are rotated clockwise so that the strip 415 moves to the left. Thus, a first portion of the strip 415 may be further wound around one of the spools (e.g., 413) while second portion of the strip is unwound around the other spool (e.g., 415) to expose another portion of the strip so that another aperture becomes aligned with the optical pathway 423 (thus, allowing light to propagate to the lens module 407 and image sensor 405). For example, FIG. 4C illustrates the possible directions of movement 425 of the spools 411, 413 and strip 415. FIG. 4C is another perspective diagram of the imaging system 401. FIG. 4C also illustrates different apertures on the strip 415 (due to the spools being rotated relative to FIG. 4A).

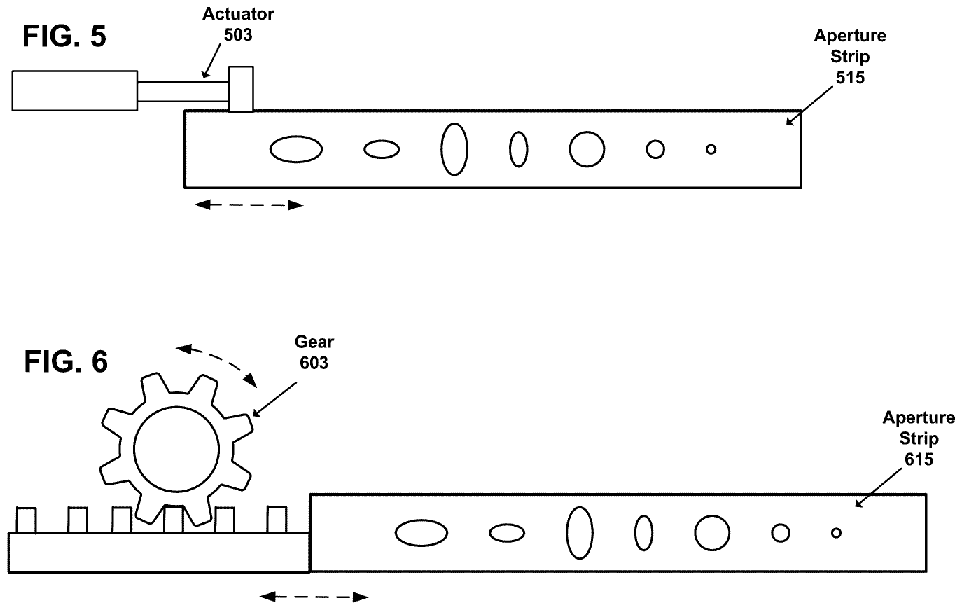

FIGS. 4A-4C illustrate a first example aperture shifter that can move an aperture strip (e.g., within a plane) relative to an optical pathway of an imaging system. Specifically, the aperture shifter in FIGS. 4A-4C includes the spools 411, 413 and rollers 419, 421, as well as one or more motors (not illustrated) configured to rotate the spools (individually or in conjunction). The spools 411 and 413 are coupled with a motor on each or on one. The motor may be controlled by a controller. Other example aperture shifters are additionally or alternatively possible to move an aperture strip. FIGS. 5-6 illustrate example aperture shifters that can move an aperture strip. FIG. 5 is a diagram of an aperture strip 515 and a linear actuator motor 503 coupled to the strip 515, according to one or more embodiments. FIG. 6 is a diagram of an aperture strip 615 (with teeth) and a gear 603 (with teeth that engage with the teeth of the strip 615), according to one or more embodiments. Although FIGS. 5-6 illustrate the aperture shifters on the left side of the strips, the aperture shifters may be on another side (e.g., the right side) or multiple sides of the strips.

FIGS. 8A-8E are diagrams of another imaging system 801 with an aperture system, according to one or more embodiments. FIG. 8A is a perspective diagram the imaging system 801. FIG. 8B is an exploded view of the imaging system 801. FIGS. 8C-8D are a cross sectional views of the imaging system 801 along a plane parallel to the xy-plane. FIG. 8E is a cross sectional view of the imaging system 801 along a plane parallel to the xz-plane.

The imaging system 801 includes an aperture strip 815, a lens module 807, an image sensor 805, and an actuator 845 (an example component of an aperture shifter). The imaging system 801 also includes a sensor 847 (e.g., hall effect sensor) to track movement of the aperture strip 815. The aperture strip 815 can slide back and forth (see dashed arrows in FIGS. 8B-8C) by the actuator 845 to align different apertures with the optical pathway. In FIG. 8C, there is extra space for the aperture strip 815 to move when it slides. In FIG. 8D, the imaging system 801 includes spools 811 that the aperture strip 815 is wrapped around (similar to imaging system 401). FIGS. 8C-8E include various guiding features 835, 837 for guiding the aperture strip 815 as it slides. These features are incorporated into the imaging system 801.

### Additional Example Aperture Systems

The below paragraphs provide additional descriptions of example imaging systems with aperture systems.

Some embodiments relate to an imaging system (e.g., 301, 401, 801) that includes an image sensor (e.g., 305, 405, 805), a strip (e.g., 315, 415, 515, 615, 815) with apertures (e.g., 317, 417), an aperture shifter (e.g., 313), and a controller (e.g., 391). A portion of the strip is located along an optical pathway (e.g., 323, 423) that directs light to the image sensor. The aperture shifter is configured to move the strip relative to the optical pathway to allow light propagating along the optical pathway to pass through one of the apertures of the strip and be incident on the image sensor (e.g., the aperture shifter is a rotary motor or a linear actuator). The controller is configured to control the image sensor and the aperture shifter.

Some embodiments relate to an imaging system (e.g., 301, 401, 801) that includes: an image sensor (e.g., 305, 405, 805); an aperture shifter (e.g., 313); a strip (e.g., 315, 415, 515, 615, 815) with a plurality of apertures (e.g., 317, 417) coupled with the aperture shifter, a portion of the strip located along an optical pathway (e.g., 323, 423), the optical pathway to pass light through an aperture of the plurality of apertures to the image sensor; and a controller (e.g., 391) coupled with the image sensor and the aperture shifter (e.g., the aperture shifter is a rotary motor or a linear actuator), the controller identifying an amount of light for the image sensor and transmitting signals to the aperture shifter to align an aperture of the strip with the optical pathway.

The aperture shifter may be configured to slide the portion of the strip in a direction substantially perpendicular (e.g., within three degrees) to the optical pathway. In some embodiments, the aperture shifter includes: (a) a first spool (e.g., 411) on a first side of the optical pathway, where at least a first subset of the strip is wound around the first spool, and (b) a second spool (e.g., 413) on a second side of the optical pathway, where at least a second subset of the strip is wound around the second spool (e.g., see FIGS. 4A-4C). The second side of the optical pathway may be on the opposite side of the first side (e.g., see FIGS. 4A-4C where spool 411 is on an opposite side of the optical pathway 423 relative to spool 413). To move the strip relative to the optical pathway, the aperture shifter may be configured to rotate one or both spools (e.g., the aperture shifter further includes a motor that rotates the spools).

In some embodiments, each aperture of the strip has a different shape, a different size, a different optical filter, or some combination thereof relative to each of the other apertures. For example, each aperture on the strip is unique relative to all other apertures on the strip (e.g., a unique combination of shape, size, and optical filter). However, in other embodiments, two or more apertures may be the same (e.g., same shape, size, and optical filter). For example, if a particular aperture combination is commonly used, the strip may have multiple instances of it spaced over the strip to reduce movement of the strip to that aperture combination.

In some embodiments, edges of the apertures of the strip are spaced apart from each other by at least a threshold distance. For example, this may reduce or eliminate aperture interference and keep each aperture distinct.

A first aperture of the strip may include an optical filter. The first aperture of the strip includes at least one of: a vertical polarizer, a horizontal polarizer, a circular polarizer, an apodization filter, neutral density filter, a linear gradient filter, or a radial gradient filter.

In some embodiments, at least one of the apertures of the strip is nonsymmetrical.

Other aspects include components, devices, systems, improvements, methods, processes, applications, computer readable mediums, and other technologies related to any of the above.

### Example Method for Capturing Images Using Different Apertures

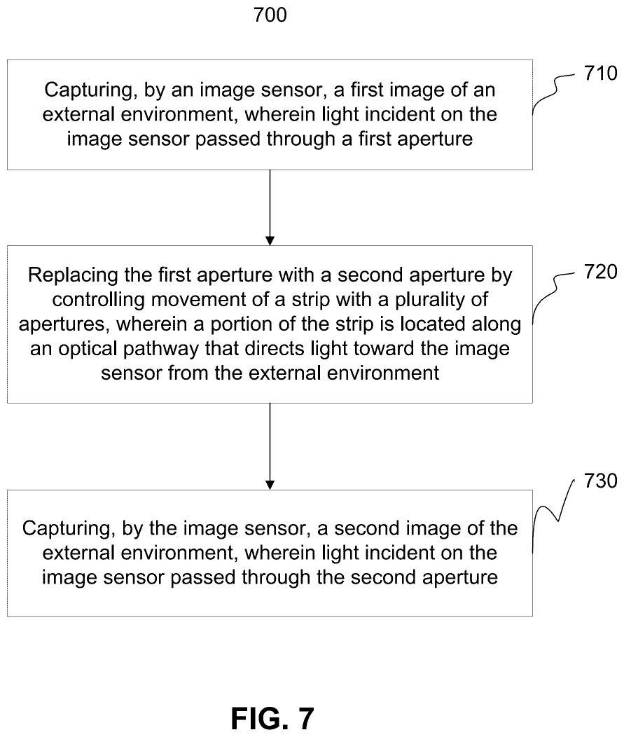

FIG. 7 is a flowchart of an example method 700 for capturing images using different apertures, according to one or more embodiments. In the example of FIG. 7, the method 700 is performed by components of an imaging system (e.g., 301, 401), such as controller 391. However, some or all of the steps may be performed by other entities or components. In addition, some embodiments may perform the steps in parallel, perform the steps in different orders, or perform different steps. Steps of method 700 may be performed by a component (e.g., controller 391) executing instructions stored on a non-transitory computer-readable storage medium.

At step 710, an image sensor (e.g., e.g., 305, 405) captures a first image of an external environment, where light incident on the image sensor passed through a first aperture (e.g., 317, 417).

At step 720, the first aperture is replaced with a second aperture by controlling movement (e.g., via controller 391) of a strip (e.g., e.g., 315, 415, 515, 615) with a plurality of apertures (e.g., 317, 417), where a portion of the strip is located along an optical pathway (e.g., 323, 423) that directs light toward the image sensor from the external environment. Replacing the first aperture with the second aperture may include sliding the portion of the strip in a direction substantially perpendicular (e.g., within three degrees) to the optical pathway.

At step 730, the image sensor captures a second image of the external environment, where light incident on the image sensor passed through the second aperture.

In some embodiments, replacing the first aperture with the second aperture includes rotating a first spool (e.g., 411) on a first side of the optical pathway, where at least a subset of the strip is wound around the first spool. Replacing the first aperture with the second aperture may further include rotating a second spool (e.g., 413) on a second side of the optical pathway, where at least a second subset of the strip is wound around the second spool. The second side of the optical pathway may be on the opposite side of the first side.

Other aspects include components, devices, systems, improvements, methods, processes, applications, computer readable mediums, and other technologies related to any of the above.

### Example Machine Architecture

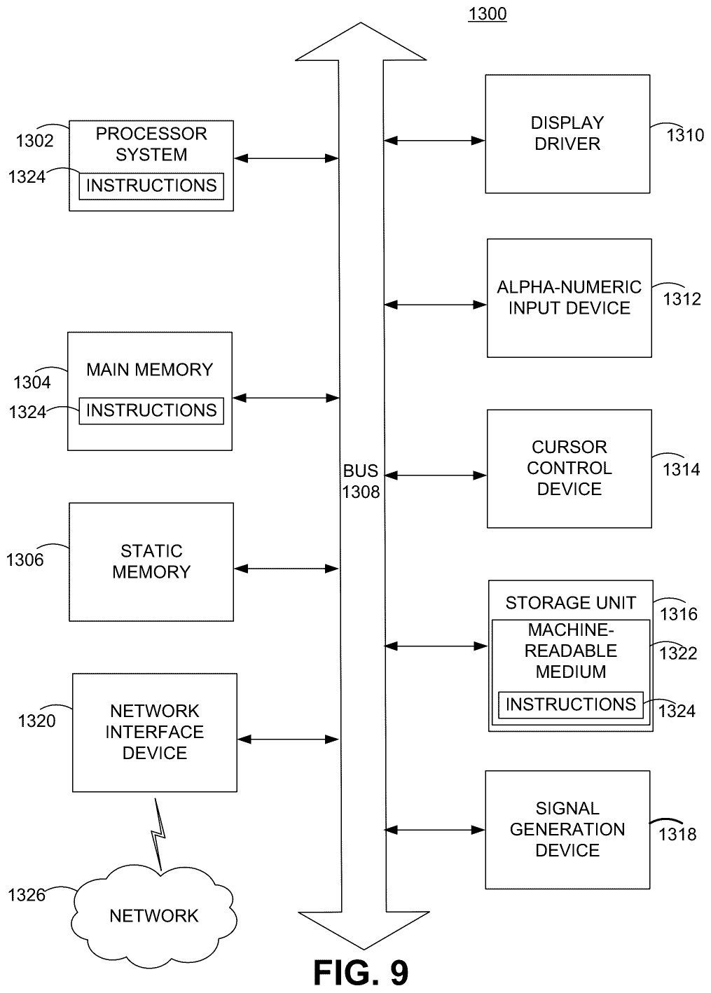

Referring now to FIG. 9, FIG. 9 is a block diagram illustrating components of an example machine able to read instructions from a machine-readable medium and execute them in a processor system. Specifically, FIG. 9 shows a diagrammatic representation of a computer system 1300 (also “computing system”). Imaging systems described herein (e.g., 101, 301, 401) may be computer systems and thus may include one or more (or all) of the components and/or functionalities described with respect to FIG. 9. The computer system 1300 can be used to execute instructions 1324 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a standalone device with processing components having a processor system and a storage as described below. The machine also may be part of a system that includes a device coupled with a server computer, a client computer, a personal computer (PC), a tablet PC, a set-top box (STB), a smartphone, an internet of things (IoT) appliance, or any machine capable of executing instructions 1324 (sequential or otherwise) that specify actions to be taken by that machine and that may be have a small volumetric area within which to incorporate an imaging system as described herein. Further, while only a single machine is illustrated, the term “machine” shall also be taken to include any collection of machines that individually or jointly execute instructions 1324 to perform any one or more of the methodologies discussed herein. The instructions may be, for example, instructions for controlling the imaging systems and/or aperture systems described with respect to FIGS. 1A- 8E.

The example computer system 1300 includes a processor system 1302 that includes one or more processing units (e.g., processors). If the processor system 1302 includes multiple processing units, the units may perform operations individually or collectively. The processor system 1302 is, for example, a central processing unit (CPU), a graphics processing unit (GPU), a neural processing unit (NPU), a tensor processing unit (TPU), a digital signal processor (DSP), a controller, a state machine, an application specific integrated circuit (ASIC), a radio-frequency integrated circuit (RFIC), or any combination of these. The computer system 1300 also includes a main memory 1304. The computer system may include a storage unit 1316. The processor 1302, memory 1304 and the storage unit 1316 communicate via a bus 1308.

In addition, the computer system 1300 can include a static memory 1306, a display driver 1310 (e.g., to drive a plasma display panel (PDP), a liquid crystal display (LCD), or a projector). The computer system 1300 may also include alphanumeric input device 1312 (e.g., a keyboard), a cursor control device 1314 (e.g., a mouse, a trackball, a joystick, a motion sensor, or other pointing instrument), a signal generation device 1318 (e.g., a speaker), and a network interface device 1320, which also are configured to communicate via the bus 1308.

The storage unit 1316 includes a (e.g., non-transitory) machine-readable medium 1322 on which is stored instructions 1324 (e.g., software) embodying any one or more of the methodologies or functions described herein. The instructions 1324 may also reside, completely or at least partially, within the main memory 1304 or within the processor system 1302 (e.g., within a processor's cache memory) during execution thereof by the computer system 1300, the main memory 1304 and the processor system 1302 also constituting machine-readable media. The instructions 1324 may be transmitted or received over a network 1326 via the network interface device 1320.

While machine-readable medium 1322 is shown in an example embodiment to be a single medium, the term “machine-readable medium” should be taken to include a single medium or multiple media (e.g., a centralized or distributed database, or associated caches and servers) able to store the instructions 1324. The term “machine-readable medium” shall also be taken to include any medium that is capable of storing instructions 1324 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, the controller module 113 and the controller module 391. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor system 1302, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor- implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for forming a combined image through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An imaging system comprising:
an image sensor;
an aperture shifter;
a strip with a plurality of apertures coupled with the aperture shifter, a portion of the strip located along an optical pathway, the optical pathway to pass light through an aperture of the plurality of apertures to the image sensor; and
a controller coupled with the image sensor and the aperture shifter, the controller identifying an amount of light for the image sensor and transmitting signals to the aperture shifter to align an aperture of the strip with the optical pathway.

2. The imaging system of claim 1, wherein the aperture shifter is configured to slide the portion of the strip in a direction substantially perpendicular to the optical pathway.

3. The imaging system of claim 1, wherein the aperture shifter includes:
a first spool on a first side of the optical pathway, wherein at least a first subset of the strip is wound around the first spool; and
a second spool on a second side of the optical pathway, wherein at least a second subset of the strip is wound around the second spool.

4. The imaging system of claim 3, wherein the second side of the optical pathway is on the opposite side of the first side.

5. The imaging system of claim 3, wherein, to move the strip relative to the optical pathway, the aperture shifter is configured to rotate the first spool and/or the second spool.

6. The imaging system of claim 1, wherein each aperture of the strip has a different shape, a different size, a different optical filter, or some combination thereof relative to each of the other apertures.

7. The imaging system of claim 1, wherein edges of the apertures of the strip are spaced apart from each other by at least a threshold distance.

8. The imaging system of claim 1, wherein a first aperture of the strip includes an optical filter.

9. The imaging system of claim 8, wherein the first aperture of the strip includes at least one of:
a vertical polarizer,
a horizontal polarizer,
a circular polarizer,
an apodization filter,
neutral density filter,
a linear gradient filter, or
a radial gradient filter.

10. The imaging system of claim 1, wherein at least one of the apertures of the strip is nonsymmetrical.

11. The imaging system of claim 1, wherein, to move the strip, the aperture shifter includes at least one of: a rotary motor or a linear actuator.

12. A method comprising:
capturing, by an image sensor, a first image of an external environment, wherein light incident on the image sensor passed through a first aperture;
replacing the first aperture with a second aperture by controlling movement of a strip with a plurality of apertures, wherein a portion of the strip is located along an optical pathway that directs light toward the image sensor from the external environment; and
capturing, by the image sensor, a second image of the external environment, wherein light incident on the image sensor passed through the second aperture.

13. The method of claim 12, wherein replacing the first aperture with the second aperture comprises sliding the portion of the strip in a direction substantially perpendicular to the optical pathway.

14. The method of claim 12, wherein replacing the first aperture with the second aperture comprises rotating a first spool on a first side of the optical pathway, wherein at least a subset of the strip is wound around the first spool.

15. The method of claim 14, wherein replacing the first aperture with the second aperture further comprises rotating a second spool on a second side of the optical pathway, wherein at least a second subset of the strip is wound around the second spool.

16. The method of claim 15, wherein the second side of the optical pathway is on the opposite side of the first side.

17. A non-transitory computer-readable storage medium storing instructions that, when executed by a computing system, cause the computing system to perform operations comprising:
capturing, by an image sensor, a first image of an external environment, wherein light incident on the image sensor passed through a first aperture;
replacing the first aperture with a second aperture by controlling movement of a strip with a plurality of apertures, wherein a portion of the strip is located along an optical pathway that directs light toward the image sensor from the external environment; and
capturing, by the image sensor, a second image of the external environment, wherein light incident on the image sensor passed through the second aperture.

18. The non-transitory computer-readable storage medium of claim 17, wherein replacing the first aperture with the second aperture comprises sliding the portion of the strip in a direction substantially perpendicular to the optical pathway.

19. The non-transitory computer-readable storage medium of claim 17, wherein replacing the first aperture with the second aperture comprises rotating a first spool on a first side of the optical pathway, wherein at least a subset of the strip is wound around the first spool.

20. The non-transitory computer-readable storage medium of claim 19, wherein replacing the first aperture with the second aperture further comprises rotating a second spool on a second side of the optical pathway, wherein at least a second subset of the strip is wound around the second spool.
